(19) United States
(12) Patent Application Publication
(10) Pub. No.: US 2011/0225034 A1
(43) Pub. Date: Sep. 15, 2011

(54) Customized Coupon Delivery System And Method

(76) Inventor: Nassim Bayat, Laguna Niguel, CA (US)

(21) Appl. No.: 12/724,341

(22) Filed: Mar. 15, 2010

(51) Int. Cl. G06Q 30/00; G06Q 10/00

(52) U.S. Cl. 705/14.36

(57) ABSTRACT

Methods and apparatus for delivering customized electronic coupons are provided. Consumer users register with the customized electronic coupon provider website and create a consumer user profile. Retailer users also register with the customized electronic coupon provider site and create a retailer user profile and electronic coupons. A software program compares the consumer user profiles with the retailer user profiles and detects matches. A customized electronic coupon is generated for each instance of a profile match. The customized electronic coupon is then delivered electronically to the consumer user.

### BACKGROUND

1. Field

The present disclosure relates generally to communication systems and, in particular, to an apparatus and method for delivering customized coupons within a communication system.

2. Background

Wireless communication systems and electronic communication systems have become a preferred communication method used by millions worldwide. Wireless communication devices have become smaller and more powerful in order to meet consumer needs and to improve portability and convenience. The increase in processing power in mobile devices, such as cellular telephones, has lead to an increase in use and popularity of these devices. More and more people turn to cell phones and computers to research before purchasing goods and services, opening up new methods for delivery of advertising and promotional materials.

Consumers looking to make a purchase in the past would consult a telephone directory or newspaper in their local area for information about retailers and vendors. Additionally, consumers or customers also had available advertising circulars or leaflets that often contained promotional coupons. These advertising circulars were frequently included with newspaper delivery or were mailed to local addresses. Advertising circulars have been left on car windshields, handed out at shopping malls, or even left on doorsteps. Telephone solicitation is yet another method of delivering advertising content and special offers. Consumers have been exposed to more advertising when watching television, listening to radio, driving past billboards, and even been passed by mobile billboards. Internet advertising has infiltrated many websites. Advertising has become ubiquitous.

With the relentless barrage of advertising, consumers are inundated with advertisements, circulars, coupons, and flyers, very few of which may target their desires, needs, or interests. Internet advertising may be somewhat more responsive, but this information may be collected without the customer's knowledge and may result in even more advertising directed the consumer's way. With so much commercial advertising many consumers ignore most of the material. As a result, few of the millions of advertisements are read, and few coupons redeemed. Some estimates place the success rate for mass advertisements in the 1-5% range. Retailers spend thousands of dollars delivering advertising and coupons to individuals who don't wish to receive this material.

While many consumers ignore many advertisements, they may still seek to obtain discount or offer coupons for various products and services that they use and prefer. This typically required laborious coupon clipping, filing, storage, and organization in order to take advantage of the offered savings. Coupons may expire before use or become lost or inadvertently destroyed. Paper coupons and advertising circulars create additional waste and disposal problems for consumers and retailers. Electronic coupons offer a mechanism for individuals and businesses to become more “green,” thus offering environmental benefits and eliminating laborious coupon clipping and filing.

In the past, coupons were offered only on the retailer's preferred schedule, not the customer's. Retailers determined the advertising campaign and delivered the ads and coupons on their schedule therefore reducing the effectiveness of the coupon. This may prevent some customers who are traveling or otherwise unavailable for taking advantage of the offer. In addition, consumers frequently return to find that desirable coupon offers have expired, and, there is still the paper to be discarded. There is a need for an apparatus and method for customized electronic coupon delivery that is responsive both to consumer preferences and retailer marketing plans.

### SUMMARY

A method for delivering customized electronic coupons to consumers is provided by embodiments of the present invention. The method comprises registering consumer users and retailer users. Both consumer users and retailer users complete a profile detailing location or other specific information to use in generating customized electronic coupons. In addition, the retailer also creates electronic coupon formats and offers for delivery to consumer users. A software program running on a computer at the coupon service provider matches consumer user preferences with retailer electronic coupons and provides for delivery of the customized electronic coupons to the consumer users. Consumer users and retailer users may specify the desired frequency of delivery. Billing software provides a mechanism to charge retailer users either on a per coupon basis for the customized electronic coupons generated of a monthly fee for service.

In one embodiment, an apparatus is provided for customizing electronic coupons. The apparatus includes an account creation module configured to allow a consumer user to create a profile. In addition, the apparatus includes an account creation module configured to allow a retailer to create a profile and electronic coupons. The apparatus further comprises a comparison module to compare consumer user profiles and retailer user profiles and select electronic coupons matching consumer user profiles. A delivery module provides for electronic coupon delivery. An accounting module bills retailer users for coupons delivered to consumer users or on a monthly fee basis.

An additional embodiment provides a means for delivery of customized electronic coupons. The apparatus includes means for registering consumer users and means for registering retailer users. Additional means for creating a consumer user profile are provided. Further means are used to create retailer user profiles and electronic coupons. Still further means compare the consumer user profiles with the retailer user profiles and electronic coupons. Means for selecting electronic coupons for matches between the consumer user profiles and the retailer user profiles and electronic coupons are also provided. Delivery means ensures that the consumer users receive the customized electronic coupons.

In yet another embodiment, a processor readable medium including instructions thereon that may be utilized by one or more processors in provided. The processor readable medium includes instructions comprising: instructions for registering consumer users; instructions for registering retailer users, and instructions for creating a consumer user profile. Instructions are also provided for creating retailer user profiles and electronic coupons. Further instructions compare the consumer user profiles with the retailer user profiles. Instructions also provide for selecting electronic coupons for matches between the consumer user profiles and the retailer user profiles. Still further instructions cause delivery of the electronic coupons.

Various aspects and embodiments of the invention are described in further detail below.

### BRIEF DESCRIPTION OF THE DRAWINGS

FIG. 1 is a block diagram of a communication system, in accordance with various embodiments of the present invention.

FIG. 2 is a block diagram of the user's side of the communication system, in accordance with one or more embodiments the present invention.

FIG. 3 is a block diagram of the retailer's side of the communication system, according to one or more embodiments of the present invention.

FIG. 4 is a block diagram of the consumer user's registration or account modification, in accordance with one or more embodiments of the present invention.

FIG. 5 is a flowchart of the consumer user's registration process, in accordance with one or more embodiments of the present invention.

FIG. 6 is a block diagram of the retailer's set-up and coupon delivery, in accordance with one or more embodiments of the present invention.

FIG. 7 is a flowchart of the retailer's set-up and coupon delivery, in accordance with one or more embodiments of the present invention.

FIG. 8 is a general overview chart of the software development process, in accordance with one or more embodiments of the present invention.

FIG. 9 is a flowchart of the software operation according to an embodiment of the present invention.

FIG. 10 is a flowchart of the software operation according to an additional embodiment of the present invention.

FIG. 11 is a block diagram of the database operation according to an embodiment of the present invention.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

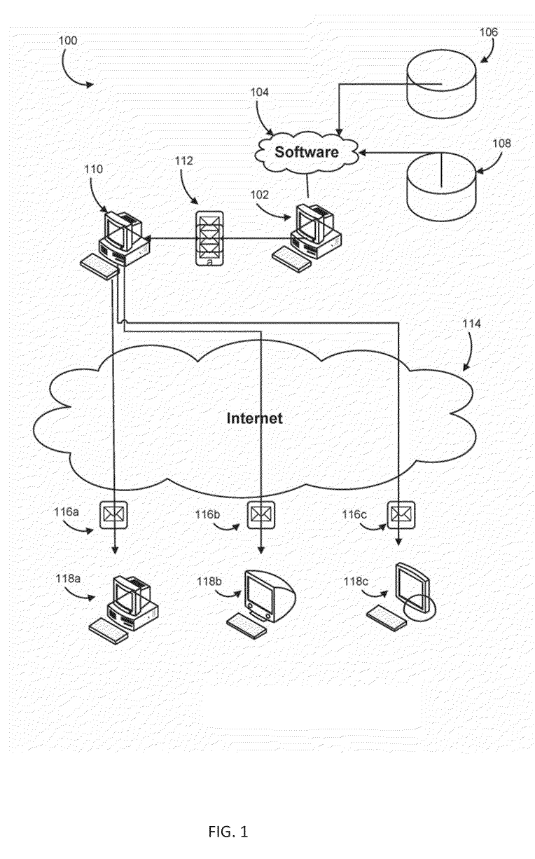

Referring to FIG. 1, a communication system 100, according to one embodiment is illustrated. Communication system 100 includes a coupon server 102 with software program 104 resident. The software 104 performs various registration and coupon generation functions as will be described below. Briefly, the software 104 matches users with electronic coupons based on location indices, such as zip codes, specific item categories, and the number of available coupons, or similar variables. The software 104 communicates with the user database 106 and the coupon database 108. The coupon server forwards coupon emails 112 to the email server 110 for delivery to registered users or customers. Electronic coupons from multiple retailers may be bundled together in an email sent to a consumer user. This offers a consumer the advantage of receiving customized electronic coupons without the disadvantage of receiving a large number of separate emails. Delivery is achieved through the Internet, 114. Each user or consumer receives customized electronic coupons, 116 a-c, based on their profile, which are delivered to the specified device 118 a-c. The consumer user's profile includes a consumer user's frequency preferences. The devices 118 a-c may be a computer, cell phone, tablet, personal digital assistant (PDA) or similar device, as long as the device is capable of an Internet connection.

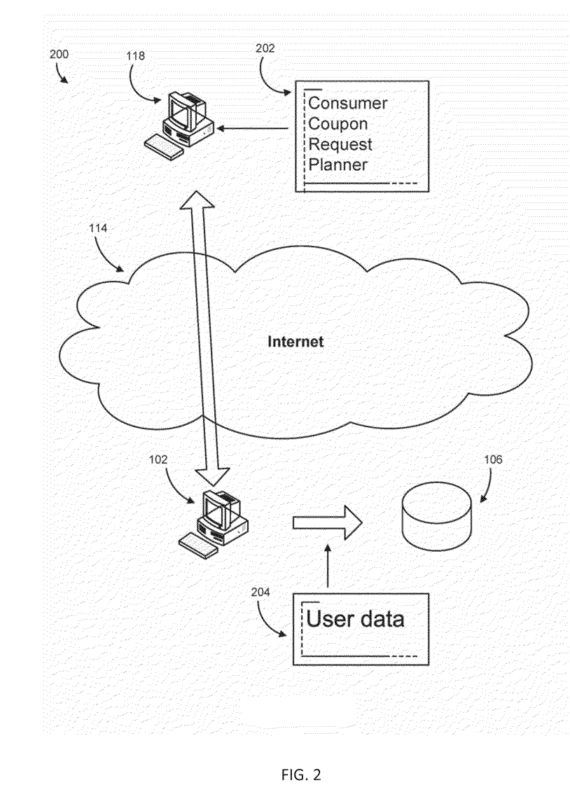

FIG. 2 illustrates the user or customer side 200 of the communication system 100. The user's personal computer 118 or similar electronic device accesses the coupon server 102, through the Internet 114. The customer completes a consumer coupon request planner, 202 in his or her web browser and submits the form to the coupon server 102 through the Internet 114. The consumer coupon request planner 202 may be in an HTML form or other appropriate web-suitable machine or database language or instructions. The consumer coupon request planner 202 may include the consumer user's zip code, city, or locality, or other location information, birthday or age information, the specific categories of electronic coupons desired, specific retailers of interest, email address. Additional optional information may include anniversaries, important dates, and gender. A consumer user sets a frequency for customized electronic coupon delivery at the time of completing the profile information in the consumer coupon request planner. The coupon server 102 receives the user-submitted data 204 and stores it in the coupon user database 106. The software 104 sends targeted electronic coupons on the schedule indicated by the consumer user using the stored information from the consumer user. If the consumer user submitted form is a registration form, an account is created for the user.

The consumer coupon request planner is a fill-in form web page that allows a consumer user to complete a profile detailing electronic coupon preferences. The consumer user reviews a yearly planner that indicates all electronic coupons requested for the entire year. Different frequencies for electronic coupon delivery may be set on the consumer coupon request planner page. The different delivery frequencies may be indicated by the use of different colors. For example, a consumer user may wish to receive a coupon weekly for a burger. The burger coupon may appear in brown, while the dry cleaning coupon, used monthly, appears in blue. This enables consumers to see instantly the different coupons they have requested. The consumer user may select the electronic coupons in the consumer coupon request planner page and change the frequency. This feature enables consumers to customize the coupons they receive and also aid in planning spending.

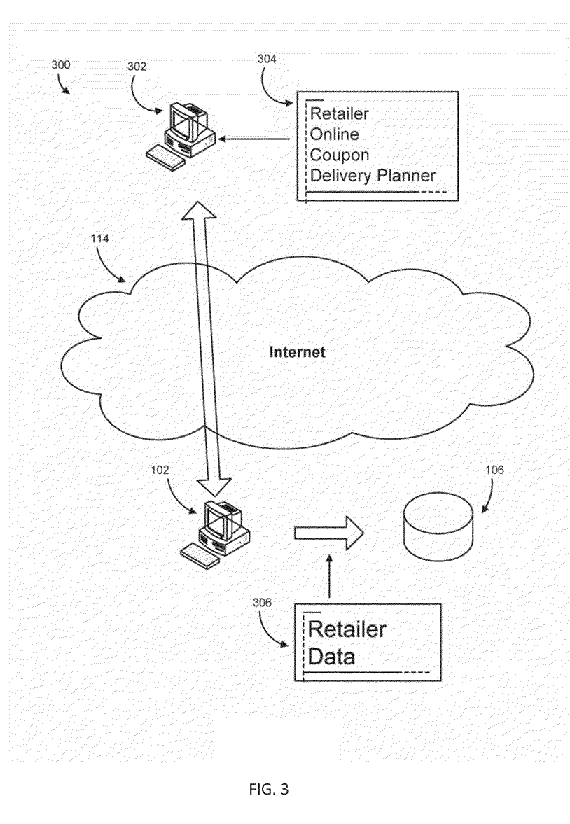

FIG. 3 illustrates the retailer side 300 of the communication system 100. The retailer's personal computer 302 or other similar device accesses the coupon server 102 through the Internet 114. The retailer completes the retailer on-line Coupon Delivery Planner 304 in his or her web browser and submits the retailer on-line Coupon Delivery Planner 304 to the coupon server 102 through the Internet 114. The retailer on-line Coupon Delivery Planner is located in the retailer user's web browser page and may be an HTML form, or other suitable form. The retailer user enters information including: the business name and location, the category of the business, contact name and information, business hours, a logo, and other information that the retailer deems relevant to consumer users. Retailers use the retailer on-line Coupon Delivery Planner to create a coupon by selecting the desired attributes of the coupon from a provided list of attributes. These attributes may include the dates the coupon is valid, any limitations on the offer, or other features found on pre-printed coupons. The retailer maybe a new user, and may include a registration form, and if so, an account is created for the retailer. Similar to the consumer coupon request planner, the retailer may view a calendar form that shows the dates planned for each coupon and any specific limits, such as the number of coupons to be offered, placed on the coupons. This allows a retailer to plan an on-line advertising campaign using one tool. The retailer may change the offering by selecting the coupon and making any desired changes. The coupon server 102 then forwards the retailer data 306 to the coupon user database 106. The retailer user information is used in conjunction with the software 104 to match retailer user offers and consumer user's preferences. In addition, a retailer may also print coupons from the Coupon Delivery Planner. These coupons may be in a variety of formats and eliminate the need for separate printing.

In a further embodiment, the retailer on-line Coupon Delivery Planner may be used to upload previously prepared electronic coupons that may have been part of a professionally prepared marketing campaign. This allows a retailer to utilize the services of a professional marketer and to institute a branding campaign across multiple media.

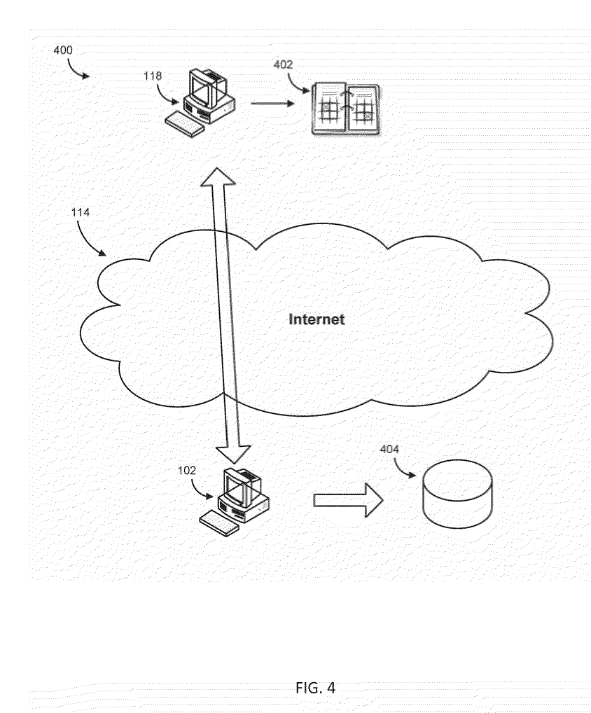

FIG. 4 illustrates consumer user operation, 400. If the consumer is new and has not set up and account and password, the consumer user is prompted to create an account and delivery schedule using a form. The consumer may then view and modify the coupon delivery preferences using the consumer coupon request planner, 402. After the user has completed or changed the consumer coupon request planner 402, the page is sent to the coupon web server 102, via the Internet, 114. At any time after initially creating an account, the consumer user may view or modify the electronic coupon delivery options on the consumer coupon request planner, 402. Using the consumer coupon request planner 402, the consumer user can change the frequency of each category or specific retailer users. Once the consumer user has completed the consumer coupon request planner 402, the coupon server 102 then transfers the consumer user information to the consumer database 404. This completed information forms a consumer user's profile. The information transferred reflects both the categories and specific retailer users selected by the consumer user.

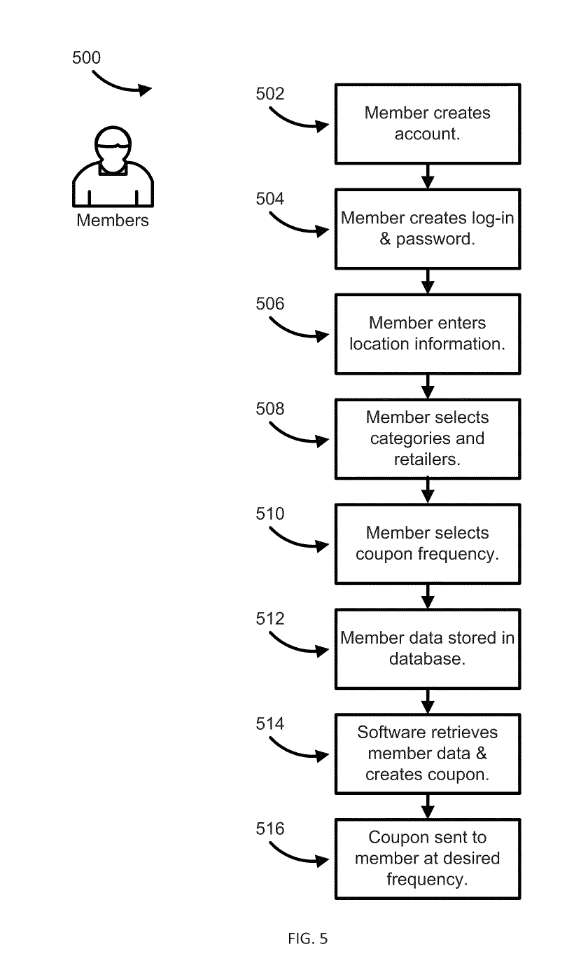

FIG. 5 is a flowchart of the registration or modification process, 500. The member, who may be a new consumer user or returning consumer user, logs onto the Internet using a web browser. The consumer user then creates an account in step 502 if an account has not previously been created. The consumer user then creates a log-in and password in step 504. In step 506 the consumer member enters location information. This location information may include a zip code, city, locality data, or other location information. The consumer then enters the categories of coupon he or she would like to receive in step 508. Specific retailers may be selected as well. To personalize the coupon offerings, the customer member or user may also enter information such as birthday or anniversary dates, and other personal information, however, this information is not required. For delivery, the consumer user provides an email address for coupon delivery.

In step 510 the consumer user selects the frequency of coupon delivery using the consumer coupon request planner 402. This selected frequency may be set for each category or for each retail outlet. For example, the consumer user may wish to receive grocery coupons weekly and dining out coupons bi-weekly. Other services, such as snow removal or specialized yard care services may be desired only a few times per year. The consumer user then sends the information over the Internet 114 to the user database 106. The user database 106 stores the consumer member information in step 514.

In step 514 the software 104 begins to create a coupon for a consumer user. The software 114 retrieves the consumer member's data and compares the data with the retailer member electronic coupons available in the coupon database 108. The created coupons 112 reflect the preferences previously provided by each consumer user.

Once the customized coupons have been created the coupons 112 are sent to the email server 110. The electronic coupons are bundled or grouped together so that each consumer user receives a single email that may contain multiple coupons. The email server 110 sends the customized electronic coupons 116 a-c to the consumer members via the Internet 114 in step 516. Each consumer user 118 a-c receives a bundle or grouping of customized electronic coupons 116 a-c created based on the previously input information. The customized electronic coupons are sent to the device 118 a-c designated by the consumer member or user at the frequency designated by the consumer. This device selected for receipt may be a computer, cell phone, PDA, or other device capable of Internet access.

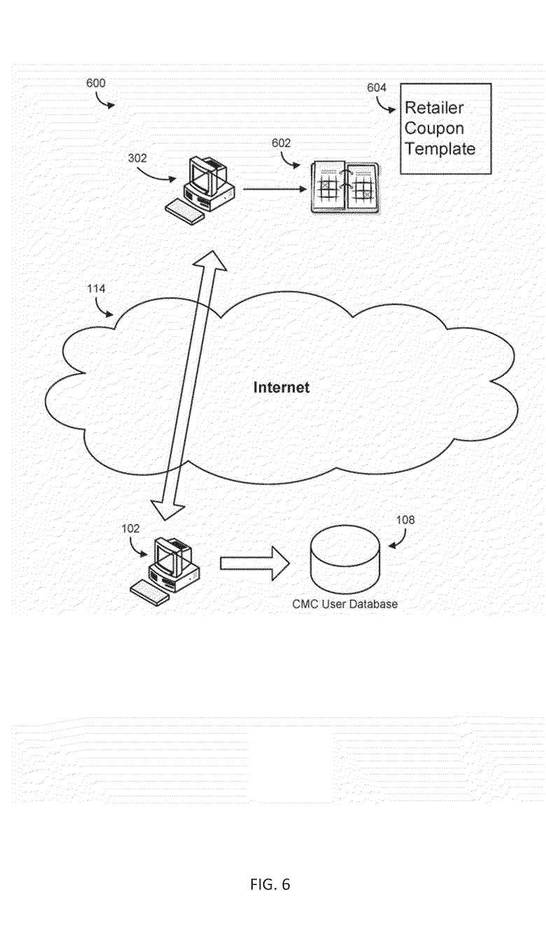

FIG. 6 is a block diagram of the retailer side 600 of the customized electronic coupon system. The retailer accesses the system using the retailer's computer 302, or other electronic device capable of Internet access. In an Internet browser, the retailer completes a retailer electronic calendar 602 and the retailer coupon template 604. The retailer user creates the electronic coupons from the provided templates and may specify an expiration date for the coupon and may also specify other restrictions on the coupon. Pre-defined restrictions are available on the coupon template 604; however, the retailer is free to add their own restrictions. As a further part of electronic coupon creation, the retailer user may set up when and how the electronic coupon should be delivered. This may include the date and time of delivery, the zip code to which the electronic coupons are to be sent to, and the number of coupons to be sent. For ease of use, retailer members may change electronic coupon effective and delivery dates by a simple drag and drop action. Retailer members may review all of their coupons on the calendar configuration web page, 602. The completion of the above information forms the retailer user's profile. These electronic coupons are then forwarded to the coupon server 102 via the Internet 114. The coupon server stores the coupon calendar 602 and the retailer coupon template 604 in the customized coupon database 108. Thereafter, the retailer's electronic coupons are ready for electronic delivery.

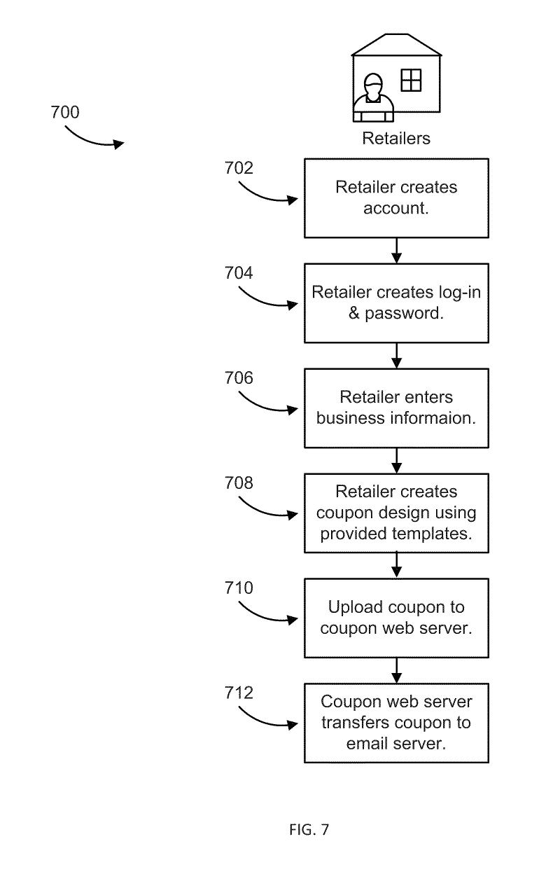

FIG. 7 illustrates the steps in the retailer member side 700 of the customized coupon process. The retailer creates an account in step 702. This account creation process is similar to that of consumer members. Once the account has been created the retailer member creates a login and password in step 704. The retailer then enters business information, including billing and other account information, in step 706. Billing may be on a monthly fee for service, in one embodiment, or a per-coupon fee in another embodiment.

The next step, 708, requires the retailer to create the desired electronic coupon using the provided template, 604 and calendar configuration web page 602. Also at the same time, the retailer member may set a limit on the number of coupons to be delivered on a first-come-first-served basis. The retailer may also provide a time limit for the promotion, with coupon distribution ceasing after a date or a specified number of electronic coupons have been delivered. The retailer may terminate the specified promotion when either the date is reached or the number of coupons is reached.

Once the retailer has created the electronic coupon, the coupons are uploaded to the coupon web server 102 in step 710. The electronic coupons are stored in the coupon database 108. The coupon web server then transfers the electronic coupon to the email server 110 in step 712 when delivery is needed. Each coupon has a unique sequence number and/or bar code. This assures authenticity and validity as well as providing tracking of coupon use.

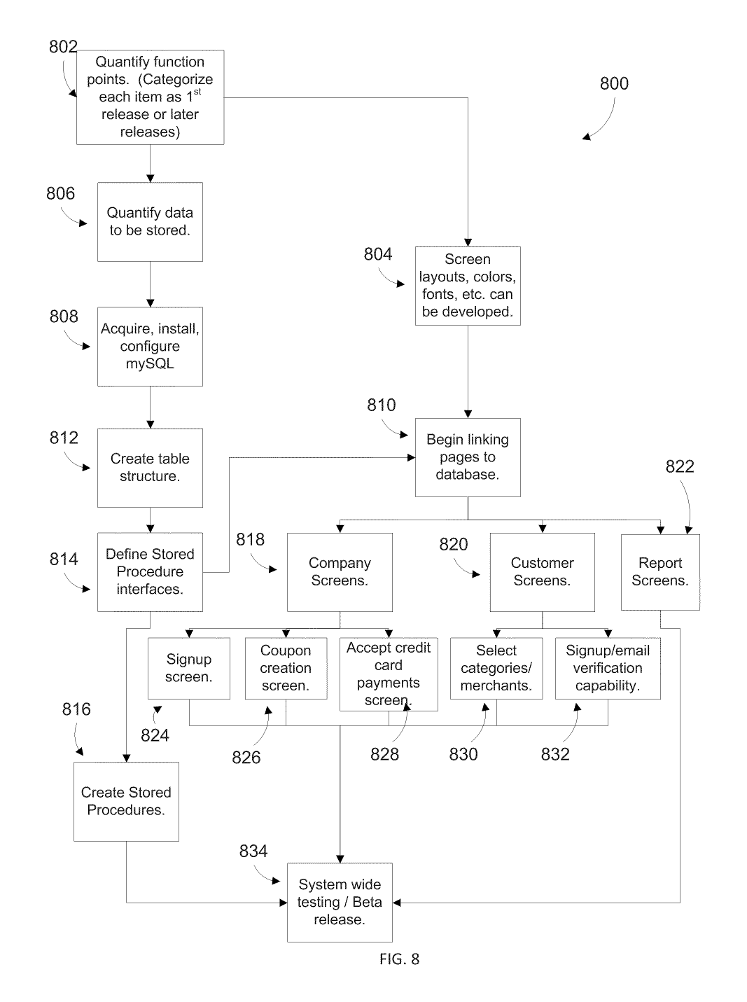

FIG. 8 provides a general overview of software 104 development used in the communication system 100. Block 802 provides for a quantify function points. This function categorizes each item as first release or later release of the software 104. Block 806 depends from block 802 and provides for quantity data to be shared. Block 808 depends from block 806 and directs the acquisition, installation, and configuration of the SQL (Structured Query Language). In block 812 a table structure is created.

The stored procedure interfaces are defined in block 814, depending from block 812. Creating stored procedures takes place in block 816, depending from block 814, as the interfaces must be defined before procedure creation.

Block 804 also depends from block 802. Block 804 provides for screen layouts colors, fonts, and similar appearance related tools. These tools allow for custom template development. Block 810 depends from block 804 and provides for the linking of pages from both customer users and retailer members in the databases 106, 108, and 404. Block 810 is also linked with block 814, where stored procedure interfaces are defined.

Company screens are provided in block 818. Various subsidiary screens to the company screens are provided in blocks 824, 826, and 828. Block 824 presents sign-up screens, while block 826 is the coupon creation screen retailer members use to create electronic coupons. Block 828 is the payment screen, where retail members enter payment information. These company screens are viewed by consumer member users who begin to create their profile and preferences for customized electronic coupons using these screens.

Block 820 provides for customer screens used by customer members to customize the electronic coupons they would like to receive. In a subsidiary block 830 customer members are provided with a category and merchant screen to make selections from. Block 832 provides for sign-up or email verification capability.

Block 834 is a beta test block, provided for the software developer. Beta test block 834 interfaces with block 816, where procedures are created and stored, blocks 824, 826, and 828 on the consumer member or user side where consumers sign-up, create coupons, and provide for payments. It should be noted, the retail members or users are the parties that will create coupons and utilize the billing provisions.

The beta test block 834 is also connected with customer screens in block 820 via the dependent blocks 830 and 832. As noted above, block 830 allows for merchant selection and block 832 provides for sign-up and email verification capability.

Report generation is provided in block 822, report screens. This report screens block 822 depends from block 810, where pages are linked to the databases and is also connected to the beta test block 834.

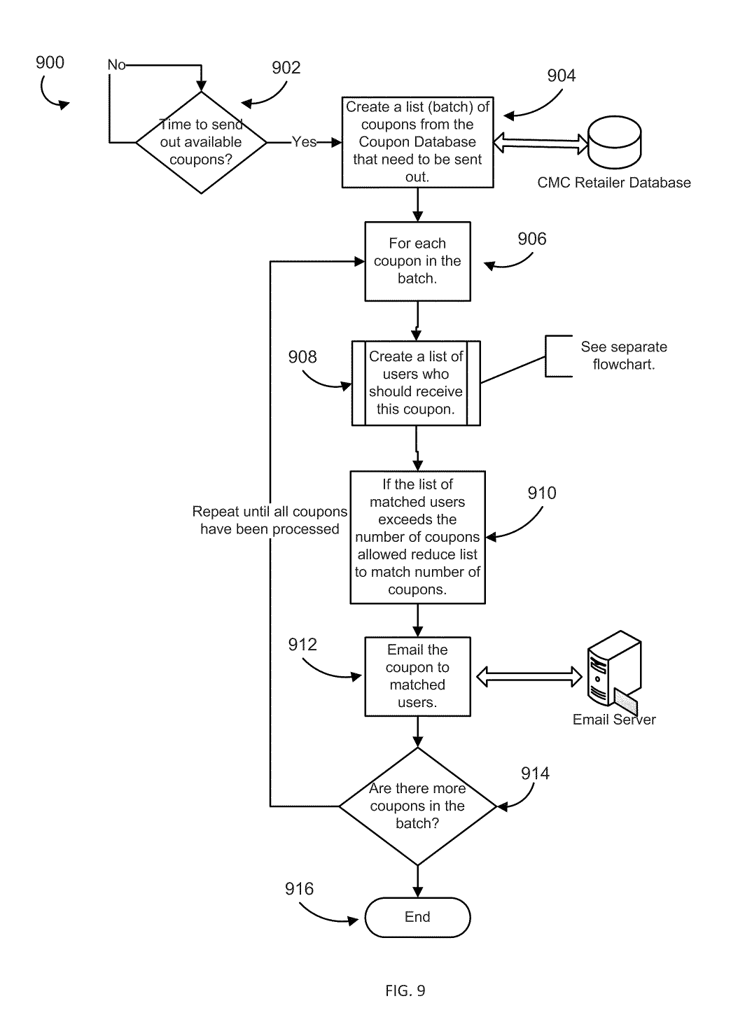

FIG. 9 provides a flowchart of the software 114 in operation. The process, 900, is used to determine which coupons from retailers are to be sent to consumer users. The process starts at step 902. In step 902 a timer is checked to see if it is time to send out available coupons. The timer may be set to a predetermined period of time, which may be adjusted by the service operator. For example, the timer may check for available coupons on an hourly schedule. If the timer indicates that it is time to check for available coupons the process proceeds to step 904. In step 904, a list of coupons is created, based on information stored in the retailer database.

Step 906 indicates that the process, including the following steps, is applied to each coupon in the batch. As the next step in the process, in step 908, a list of consumer users who are to receive coupons is created. Step 910 checks to see if the list of consumer users desiring coupons exceeds the number of available coupons. If the list does exceed the number of available coupons, priority rules are used to determine which consumers are to receive coupons. The priority rules are established by the retailer users and guide how scarce coupons are to be allotted. For example, a retailer user may want to ensure that new customers receive coupons. With new consumer users prioritized, the list of consumer users is reduced to those consumer users who meet the newness criteria established by the retailer user.

Once the list of consumer users has been established, the electronic coupon is mailed to those consumer users in step 912. In step 914 a check is made to determine if there are additional coupons in the batch to be processed. If so, the process returns to step 906 to begin handling the next coupon. In step 916 the process ends.

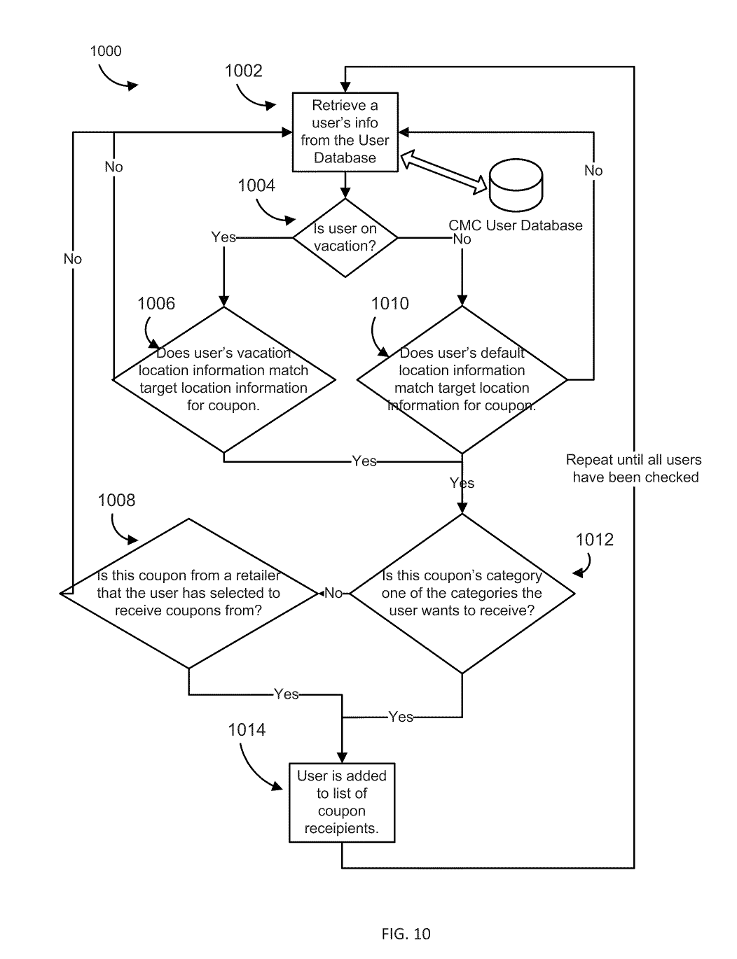

FIG. 10 illustrates in more detail the process of determining which consumer users are to receive electronic coupons. The process 1000, begins in step 1002 when a consumer user's information is retrieved from the user database. The first check is to determine if the consumer user is on vacation, or otherwise indicated that electronic coupon delivery is not to take place, which check occurs in step 1004. If the user is not on vacation, the process proceeds to step 1010.

In step 1010 a check is made to determine if the consumer user's location information matches the location information for the coupon. If a match is found, the process proceeds to step 1012 and a further check is made. Step 1012 checks to determine if the coupon's category information matches one of the categories the consumer user wishes to receive coupons for. If so, the user is added to the list of coupon recipients in step 1014. If not, the next check is to determine if the retailer is a retailer that the consumer user has chosen to receive coupons from. This check is made in step 1008. If so, the consumer user is added to the list of coupon recipients in step 1014. If not the process returns to step 1002.

If the consumer user is on vacation, as determined in step 1004, a check of the vacation location information begins in step 1006. If the consumer user's vacation location information matches the coupon location information the process proceeds to step 1012 and follows the steps described above. If the consumer user's vacation location information does not match the coupon location information the process returns to step 1002.

The location information may be used by a consumer user to receive coupons for vacation locations, as noted above, and also to receive coupons for alternate locations, such as a work or other location within driving distance. Thus, the consumer user has the choice to broaden the location information in the profile.

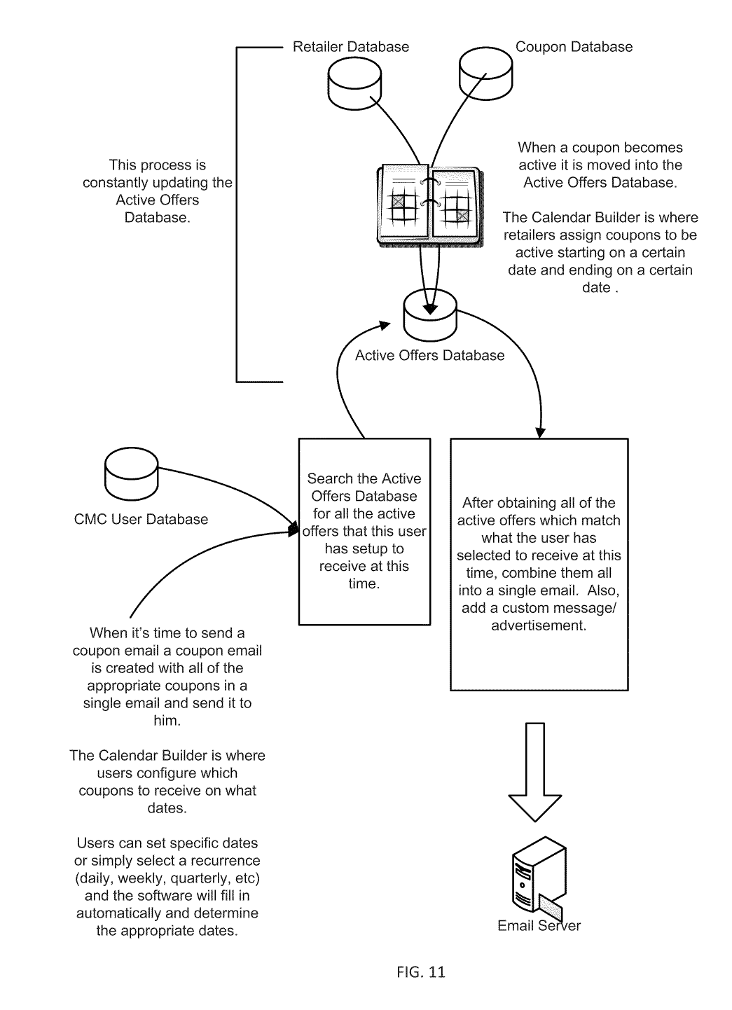

FIG. 11 illustrates the operation of the databases used in various embodiments. The retailer database contains information on the coupons each retailer is offering. The coupons are stored in the coupon database. When a coupon becomes active, it moves into the active offers database. The retail calendar builder is where retailers assign coupons to active status by indicating starting and ending dates for the promotion. The calendar builder is also where consumer users configure which coupons to receive and the recurrence frequency. Action is triggered by the frequency selected by the consumer user. The user database searches the active offers database for all the active offers that a particular consumer user has set up to receive at a certain time. After gathering all of the active coupons or offers that match the consumer user's selections, the coupons are combined into a single email to the consumer user.

In a further embodiment the user may control the time period for which a location change is in effect by also specifying a duration for the change of location. After the expiration of the specified time period, the location variable reverts to the user's original location. This embodiment allows for either a consumer user or a retail user to change location without disruption in service. This allows consumer users to be connected with retailers in other locations, that they may be familiar with, and may be helpful for consumers traveling on business or pleasure. The consumer user may select specific categories when receiving electronic coupons in a location other than their home if the consumer in the new location knows no retailers or vendors. This feature allows retailers to reach new consumers. In addition, a consumer user may have multiple profiles, each for a different location.

In a further embodiment, in addition to location change, the user may specify a period when no customized electronic coupons are to be sent. This allows a consumer user to travel and not receive unusable electronic coupons.

A still further embodiment allows the consumer users to receive electronic coupons on a portable device, such as a cell phone, in a non-email format. The electronic coupon is sent as data to the portable device application offering customized electronic coupons running software 104.

The techniques described herein may be implemented by various means. For example, these techniques may be implemented in hardware, firmware, software, or a combination thereof. For a hardware implementation, the processing units at a transmitter may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof. The processing units at a receiver may also be implemented within one or more ASICs, DSPs, processors, and so on.

For a software implementation, the transmission techniques may be implemented with instructions (e.g., procedures, functions, and so on) that perform the functions described herein. The instructions may be stored in a memory and executed by a processor. The memory may be implemented within the processor or external to the processor.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method for electronic coupon delivery, comprising:
registering consumer users;
registering retailer users;
creating a consumer user profile for each consumer user;
creating a retailer user profile and electronic coupons for each retailer user;
comparing the consumer user profile with the retailer user profile;
selecting at least one electronic coupon for each match between the consumer user profile and the retailer user profile; and
delivering the electronic coupon to the consumer user.

2. The method of claim 1 further comprising;
billing the retailer user for each electronic coupon delivered or assessing a monthly fee.

3. The method of claim 1, wherein the consumer user profile includes location information.

4. The method of claim 1, wherein the consumer user profile includes additional information about the consumer user.

5. The method of claim 1, wherein the retail user profile includes location information.

6. The method of claim 5, wherein the retail user profile includes additional information about the retailer user.

7. The method of claim 1, wherein the comparing the consumer user profile with the retail user profiles occurs on a periodic basis.

8. An electronic coupon provider computer, comprising:
an account creation module configured to allow a consumer user to create a profile;
an account creation module configured to allow a retailer user to create a profile and electronic coupons;
a comparison module to compare consumer user profiles and retailer user profiles, select electronic coupons matching consumer user profiles and deliver electronic coupons to consumer users; and
an accounting module configured to bill retailer users for each electronic coupon delivered.

9. An electronic coupon provider apparatus, comprising:
means for registering a consumer user;
means for registering a retailer user;
means for creating consumer user profiles for each consumer user;
means for creating a retailer user profile and electronic coupons for each retailer user;
means for comparing the consumer user profiles with retailer user profiles;
means for selecting electronic coupons for matches between the consumer user profiles and the retailer user profiles; and
means for delivering the electronic coupons to the consumer users.

10. The electronic coupon provider apparatus of claim 9, further comprising;
means for billing the retailer user for each electronic coupon delivered.

11. The electronic coupon provider apparatus of claim 9, further comprising:
means for including location information in the consumer user profile.

12. The electronic coupon provider apparatus of claim 9, further comprising:
means for including additional information in the consumer user profile.

13. The electronic coupon provider apparatus of claim 9, further comprising:
means for including location information in the retailer user profile.

14. The electronic coupon provider apparatus of claim 13, further comprising:
means for including additional information about the retail user in the retailer user profile.

15. The electronic coupon provider apparatus of claim 9, further comprising:
means for comparing the consumer user profile with the retailer user profiles on a periodic basis.

16. A processor readable medium including instructions thereon that may be utilized by one or more processors, the instructions comprising:
instructions for registering consumer users;
instructions for registering retailer users;
instructions for creating a consumer user profile for each consumer user;
instructions for creating a retailer user profile and electronic coupons for each retailer user;
instructions for comparing the consumer user profile with the retailer user profiles; and
instructions for delivering the electronic coupons to the consumer user.

17. The processor readable medium of claim 16, further comprising instructions for billing the retailer user for each electronic coupon or assessing a monthly fee.

18. The processor readable medium of claim 16, further comprising instructions for including location information in the consumer user profile.

19. The processor readable medium of claim 16, further comprising instructions for including additional information about the consumer user in the consumer user profile.

20. The processor readable medium of claim 16, further comprising instructions for including location information in the retailer user profile.

21. The processor readable medium of claim 19, further comprising instructions for including additional information about the retailer user.

22. The processor readable medium of claim 16, further comprising instructions for comparing the consumer user profile with the retail user profile on a periodic basis.
